(19) United States
(12) Patent Application Publication
(10) Pub. No.: US 2005/0237676 A1
(43) Pub. Date: Oct. 27, 2005

(54) Fe seeded self-pinned sensor

(75) Inventor: Hardayal Singh Gill, Palo Alto, CA (US)

Correspondence Address: ZILKA-KOTAB, PC, P.O. BOX 721120, SAN JOSE, CA, 95172-1120, US

(73) Assignee: HITACHI GLOBAL STORAGE TECHNOLOGIES

(21) Appl. No.: 10/833,347

(22) Filed: Apr. 26, 2004

(51) Int. Cl. G11B 5/33; G11B 5/127

(52) U.S. Cl. 360/324.11

(57) ABSTRACT

A magnetorestive sensor having improved pinning through the use of an Fe layer in the pinned layer structure. The pinned layer structure includes AP1 and AP2 magnetic layers separted from one another by a non-magnetic coupling layer. At least one of the AP1 and AP2 layers includes a layer of Fe which increases the intrinsic anisotropy Hk of the pinned layer structure, thereby preventing amplitude flipping.

### FIELD OF THE INVENTION

The present invention relates to magnetoresitive sensors and more particularly to a magnetoresistive sensor having improved pinned layer robustness.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of a rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating but, when the disk rotates, air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic impressions in tracks on the moving media, such as in circular tracks on the aforementioned rotating disk.

In recent read head designs a spin valve sensor, also referred to as a giant magnetoresistive (GMR) sensor, has been employed for sensing magnetic fields from the rotating magnetic disk. The sensor includes a nonmagnetic conductive layer, hereinafter referred to as a spacer layer, sandwiched between first and second ferromagnetic layers, hereinafter referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos Θ, where Θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

A spin valve sensor is characterized by a magnetoresistive (MR) coefficient that is substantially higher than the MR coefficient of an anisotropic magnetoresistive (AMR) sensor. For this reason a spin valve sensor is sometimes referred to as a giant magnetoresistive (GMR) sensor. When a spin valve sensor employs a single pinned layer it is referred to as a simple spin valve. When a spin valve employs an antiparallel (AP) pinned layer it is referred to as an AP pinned spin valve. An AP spin valve includes first and second magnetic layers separated by a thin non-magnetic coupling layer such as Ru. The thickness of the spacer layer is chosen so as to antiparallel couple the magnetizations of the ferromagnetic layers of the pinned layer. A spin valve is also known as a top or bottom spin valve depending upon whether the pinning layer is at the top (formed after the free layer) or at the bottom (before the free layer). A pinning layer in a bottom spin valve is typically made of platinum manganese (PtMn). The spin valve sensor is located between first and second nonmagnetic electrically insulating read gap layers and the first and second read gap layers are located between ferromagnetic first and second shield layers. In a merged magnetic head a single ferromagnetic layer functions as the second shield layer of the read head and as the first pole piece layer of the write head. In a piggyback head the second shield layer and the first pole piece layer are separate layers.

Sensors can also be categorized as current in plane (CIP) sensors or as current perpendicular to plane (CPP) sensors. In a CIP sensor, current flows from one side of the sensor to the other side parallel to the planes of the materials making up the sensor. Conversely, in a CPP sensor the sense current flows from the top of the sensor to the bottom of the sensor perpendicular to the plane of the layers of material making up the sensor.

The ever increasing demands for data density and data rate have required ever smaller track widths and ever smaller stack height. Decreasing the track width of a sensor increases the number of tracks that can be fit onto a given disk, and therefore increases the data density of the disk. Decreasing the stack height (ie. the height of all of the layers making up the sensor) increases the number of bits per inch of signal track and therefore, increases data density and data rate. However, these ever decreasing track widths and stack heights present extreme challenges to sensor design and in many cases can overcome the limits of conventional sensor design.

For example, decreasing trackwidth can decrease the pinning mechanisms that are used to keep a pinned layer pinned in a desired direction. If pinning is provided by exchange coupling with a layer of antiferromagnetic material such as PtMn, the decreased track width leads to decreased surface area for exchange coupling and, therefore, leads to decreased pinning strength. A catastrophic event such as a contact of the head with the disk, leading to a brief heat spike, can cause the pinned layer to temporarily lose its pinning and flip directions, rendering the sensor inoperable.

To make matters worse, in efforts to decrease the stack height of a sensor, some designs have adopted self pinned sensors. Self pinned sensors use the high magnetostriction of selected pinned layer materials, in combination with compressive stresses intrinsic to sensors, to pin the magnetizations of the pinned layers. Since antiferromagnetic (AFM) layers used in conventional AFM pinned sensor are very thick relative to the other layers in a sensor, eliminating the AFM layer greatly decreases the stack height of the sensor. While the use of self pinned sensors provides great advantages in stack height reduction, it also presents challenges to pinning integrity. For example, as mentioned above the compressive stresses in the sensor are needed to generate the desired pinning in the pinned layer. A temporary strain on the sensor such as from a contact of the sensor with the disk can briefly reduce or eliminate this compressive stress leading to a loss of pinning. This can allow the pinned layers to flip, rendering the sensor useless.

Therefore, there is a need for a mechanism for increasing the pinning robustness of a pinned layer structure in a magnetoresistive sensor. Such a mechanism would preferably be usefull for use in either a CPP or CIP GMR sensor or in a tunnel valve, and would also be usefull in either a conventional AFM pinned sensor or in a self pinned sensor.

### SUMMARY OF THE INVENTION

The present invention provides a magnetoresistive sensor having improved pinned layer stability provided by increased intrinsic anisotropy of the pinned layer structure. A sensor according to the present invention includes a pinned layer structure and a free layer structure. The pinned layer structure includes an AP1 layer and an AP2 layer each separated from one another by a non-magnetic coupling layer. The AP1 layer include a first layer comprising Fe and a second layer comprising CoFe.

The presence of the Fe in the AP1 layer increases the intrinsic anisotropy of the pinned layer structure, which assists pinning and prevents amplitude flipping. The direction of the anisotropy can be controlled by depositing the layers of the pinned layer in the presence of a magnetic field.

The increased anisotropy of the pinned layer is especially beneficial for use with a self pinned free layer, although it is also beneficial for use in a conventionally pinned (AFM pinned) pinned layer. In a self pinned structure, pinning is provided by compressive stresses in the sensor, which when combined with a high magnetoresistance of the materials making up the pinned layers caused the magnetization to remain pinned in a desired direction perpendicular to the ABS. If for some reason the sensor loses its compressive stress (such as due to deformation during head/disk contact) the pinned layer magnetization could, if not incorporating the present invention, lose pinning and flip direction. The present invention prevents such flipping under such circumstances by adding an intrinsic anisotropy that does not diminish when the compressive stresses on the sensor are moved.

In addition to providing advantageous intrinsic anisotropy in the sensor, Fe layer in also promotes a desired body centered cubic (BCC) structure in the subsequently deposited layers of the pinned layer.

### BRIEF DESCRIPTION OF THE DRAWINGS

For a fuller understanding of the nature and advantages of this invention, as well as the preferred mode of use, reference should be made to the following detailed description read in conjunction with the accompanying drawings.

FIG. 1 is a schematic illustration of a disk drive system in which the invention might be embodied;

FIG. 2 is an ABS view of a slider illustrating the location of a magnetic head thereon;

FIG. 3 is an ABS view of a magnetic sensor according to an embodiment of the present invention taken from circle 3 of FIG. 2; and

FIG. 4 is an ABS view of a magnetic sensor according to an alternate embodiment of the invention.

### BEST MODE FOR CARRYING OUT THE INVENTION

The following description is of the best embodiments presently contemplated for carrying out this invention. This description is made for the purpose of illustrating the general principles of this invention and is not meant to limit the inventive concepts claimed herein.

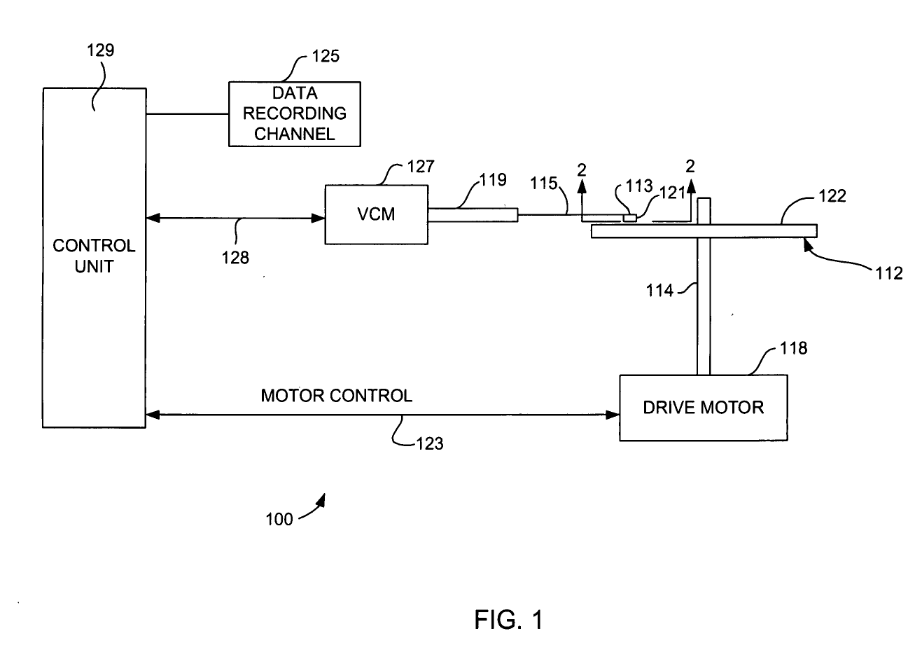

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

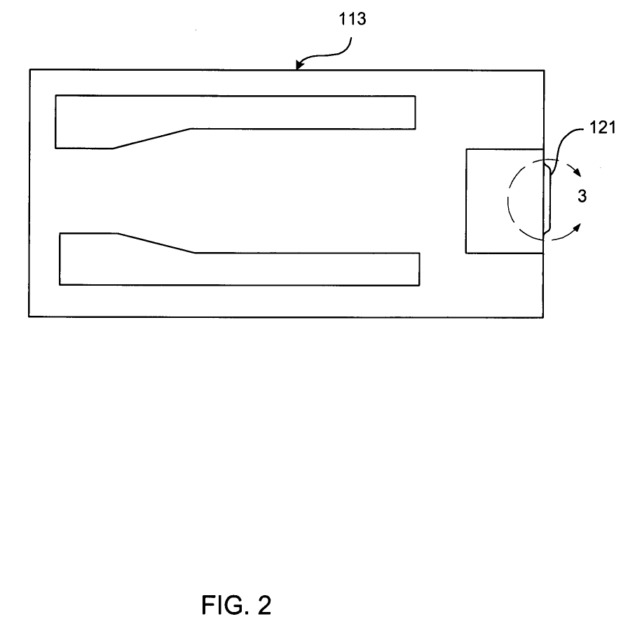

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

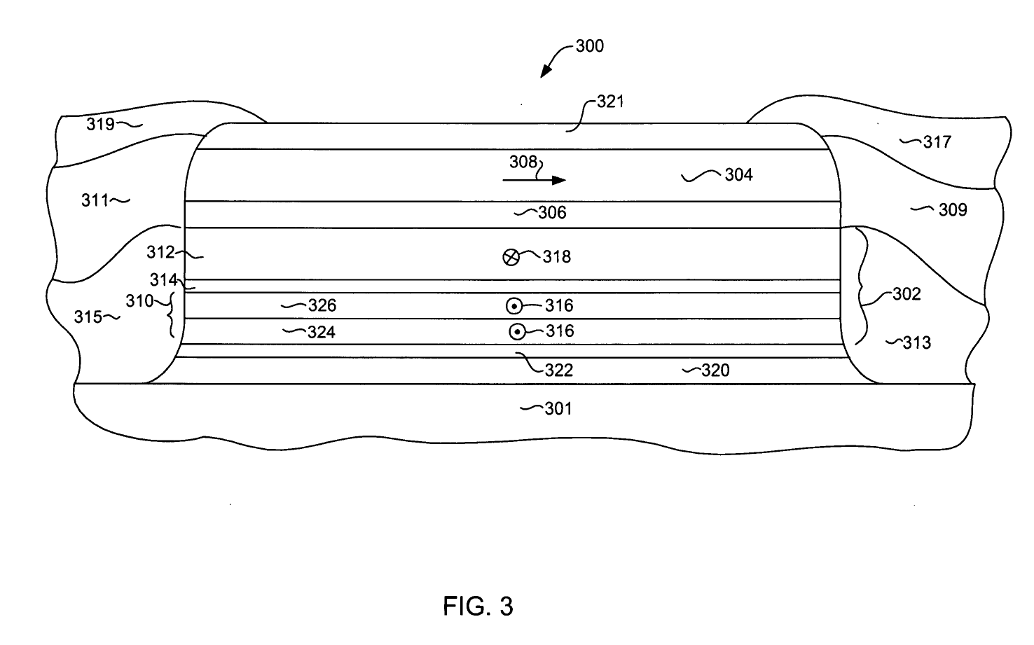

With reference now to FIG. 3, a magnetoresistive sensor 300 according to an embodiment of the present invention is constructed upon a substrate 301, such as alumina or some other dielectric material which is formed above a write element (not shown). The sensor 300 includes a pinned layer structure 302 and a free layer structure 304. A non-magnetic spacer layer 306 is sandwiched between the pinned layer structure 302 and the free layer 304. The free layer has a magnetization that is biased parallel to the ABS as indicated by arrow 308, but is free to rotate in response to a magnetic field such as from an adjacent magnetic medium. first and second hard bias layers 309, 311 are provided at either side of the sensor adjacent the free layer 304 to provide magnetic biasing to keep the magnetization 308 of the free layer biased in the desired direction parallel with the ABS. The bias layer is preferably constructed of a magnetically hard (high H_{c}) material such as CoPtCr or the like. Electrically insulating fill layers 313, 315 may be provided below the bias layers 309, 311 and, if included, would be constructed of such a thickness as to place the bias layers 309, 311 in line with the free layer 304. Alternatively, the fill layers 313, 315 could be eliminated and the hard bias layers 309, 311 could be made thick enough to reach the level of the free layer 304.

The present embodiment of the invention is a current in plane (CIP) GMR sensor in that sense current flows from one lateral edge of the sensor to the other parallel with the planes of the layers. To this end, first and second electrically conductive leads 317, 319 are provided above the bias layers 309, 311. The electrically conductive leads may be constructed of for example Cu or Au or some other electrically conductive material. A capping layer 321 such as Ta may also be provided to protect the sensor from damage such as by corrosion.

With continued reference to FIG. 3, the pinned layer 302 includes a first magnetic layer (AP1) 310 and a second magnetic layer (AP2). A non-magnetic antiparallel coupling layer 314, constructed of for example Ru, is sandwiched between the AP1 and AP2 layers 310, 312, and is constructed of a thickness so as to anti-parallel (AP) couple the AP1 and AP2 layers 310, 312. The AP coupling of the AP1 and AP2 layer results in first and second magnetizations directed 180 degrees to one another perpendicular to the ABS as indicated by symbols 316, 318.

A layer of for example Ta 320 may be formed beneath the pinned layer structure 302 on the substrate 301. A seed layer 322, which is preferably NiFeCr but could be some other material, may also be deposited on the Ta layer 320 beneath the pinned layer structure 302. The seed layer 322 promotes the desired body centered cubic (BCC) crystallographic structure in the subsequently deposited layers.

The first magnetic layer AP1 310 includes a first AP1 magnetic layer 324 comprising Fe, and a second AP1 magnetic layer 326 comprising for example CoFe having substantially 50 atomic percent Co and 50 atomic percent Fe (Co₅₀Fe₅₀). The AP2 layer is preferably constructed of CoFe having substantially 90 atomic percent Co and 10 atomic percent Fe. It has been found that Co₉₀Fe₁₀ provides beneficial GMR performance (dr/R) when used in a CIP sensor. For purposes of the present invention, atomic percentages of “substantially” 50/50 or 90/10 means about plus or minus 5 atomic percent.

In the presently described embodiment, pinned layer pinning is maintained primarily by several factors. First, the materials making up the AP1 and AP2 layers 310, 312 have a strong positive magnetostriction. Sensors such as the one described herein inevitably have compressive stresses within them as a result of pressure provided from the layers such as the bias layers 309, 311, fill layers 313, 315 if present, and leads 317, 319. These compressive stresses combined with the positive magnetostriction of the AP1 and AP2 layers magnetize the sensor in the desired direction 316, 318 perpendicular to the ABS.

In addition, the magnetic thicknesses of the AP1 and AP2 layers are substantially the same, which results in a strong antiparallel coupling across the coupling layer 314 and promotes pinning of the pinned AP1, AP2 layers 310, 312. The first and second magnetic layers 324, 326 of the AP1 layer 310 each have a magnetic thickness that summed together define the thickness of the AP1 layer. The magnetic layers 324, 326 could have magnetic thicknesses of, for example 10 angstroms each, in which case the magnetic thicknesses of the AP1 and AP2 layers 310, 312 are about 20 angstroms each. For purposes of the present description, substantially the same thickness of the AP1 and AP2 layers 310, 312 means that they are within plus or minus 5 angstroms of one another.

As provided by the present invention, pinning of the pinned layer structure 302 is further enhanced by strong intrinsic anisotropy (high Hₖ) of the AP1 layer. When CoFe is formed on top of a layer of Fe, the layers develop a strong intrinsic magnetic anisotropy. The direction of this magnetic anisotropy can be controlled by depositing the layers 324, 326 (such as by sputtering) in the presence of a magnetic field. This intrinsic anisotropy is beneficial for at least a couple of reasons. First the strong anisotropy assists pinning during normal operation of the sensor making the sensor more robust. Second, the strong intrinsic anisotropy promotes pinning (preventing amplitude flipping) during a catastrophic event. As discussed, one of the primary mechanisms for pinning this self pinned sensor is the compressive stresses present in the sensor 300 combined with the positive magnetostriction of the AP1 and AP2 layers 310, 312. If that stress ceases even momentarily, for example due to head disk contact, the pinning provided by the positive magnetostriction of the layers would momentarily disappear, leaving the pinned layer prone to amplitude flipping. The intrinsic anisotropy of the AP1 layer, however, is independent of the mechanical stress on the sensor 300. Therefore, during what would previously have been a catastrophic event such as a head disk contact the intrinsic anisotropy provided by the AP1 layer will maintain the desired pinning, preventing the pinned layer from flipping direction.

While the Fe layer 324 provides beneficial intrinsic anisotropy, another advantage is its contribution to expitaxial growth of the subsequently deposited layers. The Fe layer has a desirable body centered cubic BCC structure. This BCC structure encourages beneficial BCC crystalographic growth of the subsequently deposited layers, such as the second layer 326 of the AP1 layer 310 as well as the AP2 layer and subsequently deposited layers. It should be pointed out that while the presently described embodiment is described as being a self pinned sensor, the present invention could be also be practiced with a conventionally pinned sensor, in which case the sensor would include a layer of antiferromagnetic material disposed below and in contact with the pinned layer.

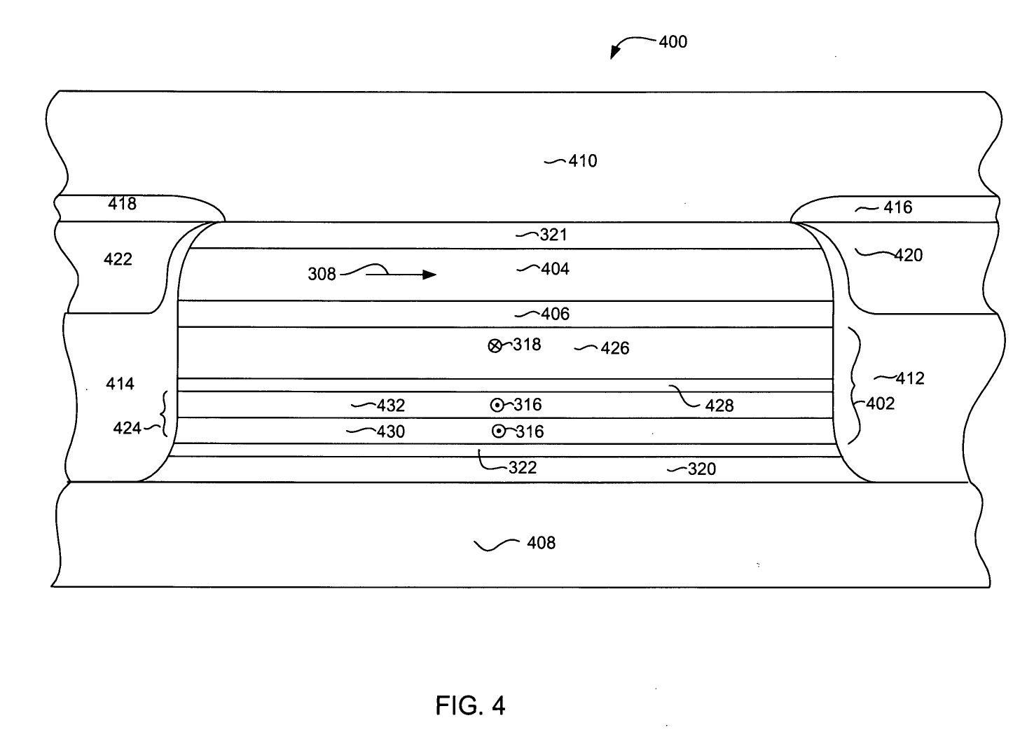

With reference now to FIG. 4, a CIP GMR sensor 400 includes a pinned layer structure 402, a free layer structure 404 and a spacer layer 406 sandwiched therebetween. For purposes of illustration, the sensor 400 will be described herein as a current perpendicular to plane (CPP) GMR sensor, and as such the spacer layer 406 will be a non-magnetic, electrically conductive material, preferably Cu. The present invention could also be practiced with a tunnel valve sensor, which would have a similar structure except that, as those skilled in the art will recognize, the spacer layer 406 would be an electrically non conductive material such as alumina.

With continued reference to FIG. 4, first and second shields 408, 410 also function as leads for the sensor conducting sense current to the sensor 400, which current would then be conducted through the sensor perpendicular to the planes of the various layers.

At the lateral extremities of the sensor are first and second lower insulation layers 412, 414 and first and second upper insulation layers 416, 418. The upper and lower insulation layers 412, 414, 416, 418 can be constructed of for example alumina (Al₂O₃) or some other dielectric material. First and second hard bias layers 420, 422 can also be provided at the level of the free layer 404 to provide magnetic biasing for the free layer 404. As can be seen with reference to FIG. 4, the lower insulation layers 412, 414 have a thin portion adjacent to the sensor that extends upward to prevent electrical current from being shunted from the sides of the sensor during operation.

As with the previously described embodiment, the pinned 402 of sensor 400 includes an AP1 layer 424 and an AP2 layer 426 each of which is separated from the other by an AP coupling layer 428. The AP1 layer 424 includes a first layer 430 consisting essentially of Fe, and a second layer 432 comprising CoFe with substantially equal parts Co and Fe (ie. Co₅₀Fe₅₀). The first layer 430 is formed below the second layer 432. In the presently described embodiment the AP2 layer 426 comprises CoFe having substantially 90 atomic percent Co and 10 atomic percent Fe. It has been found that when used in a CPP GMR or in a Tunnel valve, constructing the AP2 layer to includes a substantially higher percentage of Co relative to Fe improves dr/R.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A magnetoresistive sensor comprising:
a magnetic free layer;
a magnetic pinned layer structure; and
a spacer layer sandwiched between the magnetic free layer and the magnetic pinned layer structure;
the magnetic pinned layer structure comprising:
a first pinned layer (AP1) comprising a layer consisting essentially of Fe and a layer comprising CoFe, the AP1 layer having a first magnetic thickness equal to the sum of a magnetic thickness of said Fe layer and a magnetic thickness of said CoFe layer; and
a second pinned layer (AP2) comprising CoFe, having a second magnetic thickness.

2. A magnetoresistive sensor as in claim 1 wherein said first and second magnetic thicknesses of said AP1 layer and said AP2 layer are substantially equal.

3. A magnetoresistive sensor as in claim 1, wherein said first and second thicknesses are within 5 angstroms of one another.

4. A magnetoresistive sensor as in claim 1, wherein said CoFe layer of said AP1 layer comprises substantially 50 atomic percent Co and 50 atomic percent Fe.

5. A magnetoresistive sensor as in claim 1, wherein said sensor is a current perpendicular to plane GMR sensor and said AP2 layer comprises CoFe having substantially 50 atomic percent Co and 50 atomic percent Fe.

6. A magnetoresistive sensor as in claim 1, wherein said sensor is a tunnel valve and said AP2 layer comprises CoFe having substantially 50 atomic percent Co and 50 atomic percent Fe.

7. A magnetoresistive sensor as in claim 1, wherein said sensor is a current perpendicular to plane GMR sensor and said AP2 layer comprises CoFe having substantially 90 atomic percent co and 10 atomic percent Fe.

8. A magnetoresistive sensor as in claim 1, further comprising a layer of antiferromagnetic material, and wherein said pinned layer structure is pinned by exchange coupling of one of said AP1 and AP2 layers with said layer of antiferromagnetic material.

9. A magnetoresistive sensor as in claim 1, wherein said pinned layer structure is self pinned without exchange coupling with a layer of antiferromagntic material.

10. A magnetoresistive sensor as in claim 9, wherein said pinned layer is pinned by a combination of positive magnetostriction of one or more layers of the pinned layer structure combined with compressive stresses in the sensor.

11. A magnetoresistive sensor as in claim 10 wherein said self pinning of said pinned layer structure is assisted by intrinsic anisotropy Hₖ of said AP1 layer.

12. A magnetoresistive sensor as in claim 1 wherein said AP1 layer is disposed adjacent said non-magnetic spacer layer.

13. A magnetoresistive sensor as in claim 1 wherein said AP2 layer is disposed adjacent said non-magnetic spacer layer.

14. A magnetoresistive sensor as in claim 1 further comprising a seed layer disposed adjacent said pinned layer structure distal from said non-magnetic spacer layer, said seed layer comprising NiFeCr.

15. A magnetoresistive sensor as in claim 14 further comprising a layer of Ta formed adjacent said seed layer distal from said pinned layer structure.

16. A magnetoresistive sensor as in claim 1, wherein said non-magnetic spacer layer comprises Cu.

17. A magnetoresistive sensor as in claim 1, wherein said non-magnetic spacer layer comprises an electrically insulating barrier layer.

18. A magnetoresistive sensor as in claim 1, wherein said non-magnetic spacer layer comprises an alumina barrier layer.
